(19) United States
(12) Patent Application Publication
(10) Pub. No.: US 2010/0267321 A1
(43) Pub. Date: Oct. 21, 2010

(54) Air curtain-isolated biosafety cabinet

(75) Inventors: Rong Fung Huang, Taipei (TW); Tung-Sheng Shih, Taipei (TW); Cheng-Ping Chang, Taipei (TW); Chun-Wan Chen, Taipei (TW); Chen-Hsiung Hung, Taipei City (TW)

Correspondence Address: Jackson Intellectual Property Group PLLC, 106 Starvale Lane, Shipman, VA, 22971, US

(73) Assignee: Institute of Occupational Safety and Health, Council of Labor Affairs, Executive Yuan, Taipei (TW)

(21) Appl. No.: 11/812,985

(22) Filed: Jun. 22, 2007

(51) Int. Cl. B08B 15/02

(52) U.S. Cl. 454/56

(57) ABSTRACT

A biological safety cabinet (BSC) has an air curtain to isolate air inside and outside the BSC. A most preferable slight concave curtain of air can be obtained. With the curtain, neither contamination in the BSC leaks out nor outside contamination enters the BSC. Furthermore, no circulation is formed in the BSC by blowing the air curtain. Thus, the operator using the BSC and the product in the BSC are both well protected.

### FIELD OF THE INVENTION

The present invention relates to a biosafety cabinet (BSC); more particularly, relates to forming an air-isolator at an opening of a door to isolate air flows inside and outside the BSC, to prevent circulations in the BSC, and to prevent contamination leakage from the BSC.

### DESCRIPTION OF THE RELATED ARTS

In many microbiological experiments or procedures, biological dangers may do harm to operators. BSC is used to protect germs in the cabinet and to prevent contamination inside from leaking out.

Although BSC is used to protect germs in the cabinet and to protect the operator, events keep on happening that operators died because of contamination. It shows that BSC still has some problem. In an actual operation, there are two types of problems: (1) not obtaining the most proper design: They include insufficient suction amount, improper suction slot position, improper air supplier position, uneven flow rate at front opening, bad opening shape design, etc.; and (2) not operating in a best state: They include that the contamination is too much, the opening is too wide opened, that the suction amount is not well adjusted following an actual situation, etc.

According to NSF/ANSI 49, 2002, which is a newly revised standard for a level II BSC, the BSCs can be divided into four categories: A1, A2, B1 and B2.

Clark and Mullan, Rake, Kennedy, Kruse, etc. test BSCs for capabilities in exhausting contamination and found that the level II BSC can not resist a sudden change in indoor air pressure. Hence, the capability in exhausting contamination for a level II BSC has to be improved.

In the B2 BSC, waste gases are totally exhausted without recycling; all gases are flowed through HEPA filter; and the gases are exhausted to the exhausting system of a building. The BSC has a HEPA filter on top to supply air by an air blower. Thus, outer air is not allowed to enter the cabinet directly; and environments inside and outside the cabinet are separated. Then the air is exhausted by an air-suction device at a rate of 0.57 cubic meters per second for obtaining a negative pressure in the cabinet. And, if air supply is not enough, a sash may be opened to supply air into the BSC from outside. Yet, in such a situation, the contamination in the BSC may leak out at the opening by the interference of the outside flow and/or the action of the BSC door. Therefore, traditional BSC is weak in defending interferences of side flow and door operation. Hence, the prior art does not fulfill all users' requests on actual use.

### SUMMARY OF THE INVENTION

The main purpose of the present invention is to prevent contamination leakage from the BSC and to prevent circulations in the BSC.

To achieve the above purpose, the present invention is an air curtain-isolated BSC, comprising a main body, a door, an air blower, a suction box, a gas sucker, a plurality of cross flow fans and a high efficiency particulate air (HEPA) filter, where the main body has a space to contain a harmful gas to be exhausted and has an open space at a side; the door is movably assembled to the main body at the side to control an opening and has an air-pushing veil; the air blower is connected to an air inlet on top of the main body to supply fresh air; the suction box is set beneath the main body and has a suction slot at an edge of the main body corresponding to the air-pushing veil of the door; the gas sucker is set at an exit of the suction box for exhausting the harmful gas; the HEPA filter is set on top of the main body to supply air by the air blower; and air flows inside and outside the BSC is isolated to prevent operators from damages owing to leakage of the contamination in the BSC, and to prevent contamination outside of the BSC from entering into the BSC to pollute a product in the BSC. Accordingly, a novel air curtain-isolated BSC is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the perspective view showing the preferred embodiment according to the present invention;

FIG. 2 is the side view showing the preferred embodiment;

FIG. 3 is the view showing the preferred embodiment with the coordinated devices;

FIG. 4 is the view showing the straight curtain;

FIG. 5 is the view showing the slightly concave curtain;

FIG. 6 is the view showing the severely concave curtain; and

FIG. 7A to FIG. 7C are the views showing the changes of the oscillating curtain at different times.

### DESCRIPTION OF THE PREFERRED EMBODIMENT

The following description(s) of the preferred embodiment(s) is/are provided to understand the features and the structures of the present invention.

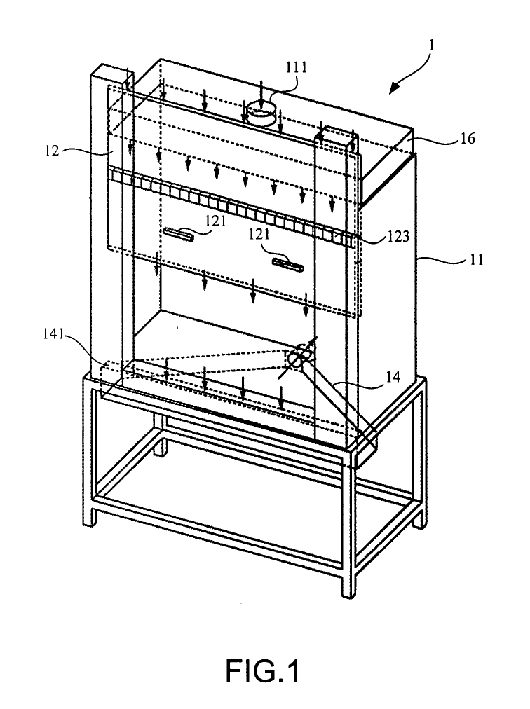

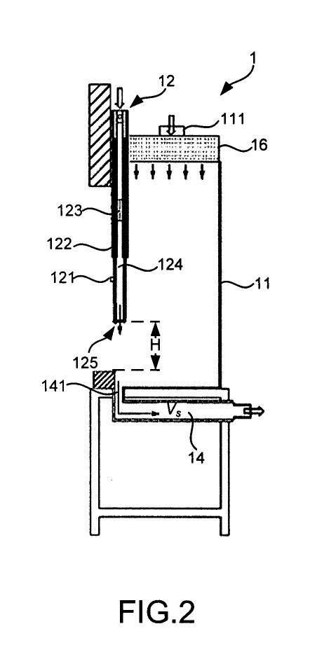

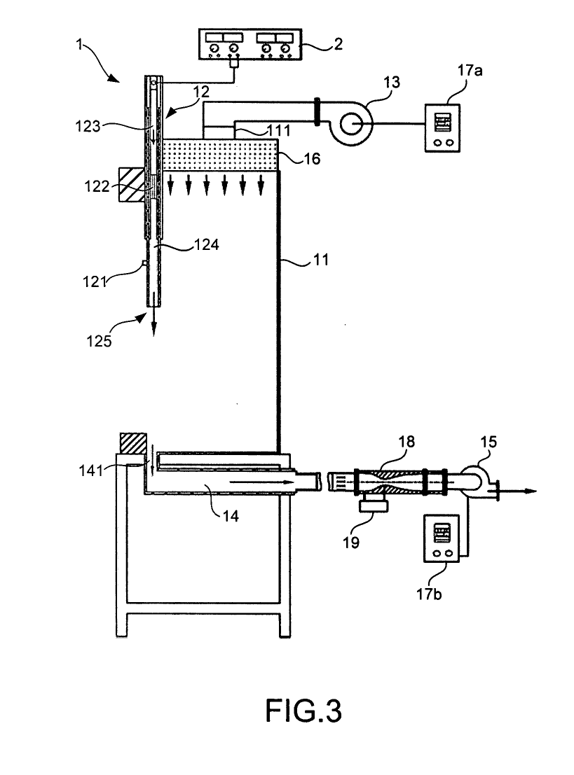

Please refer to FIG. 1 to FIG. 3, which are a perspective and a side views showing a preferred embodiment according to the present invention; and a view showing the preferred embodiment with coordinated devices. As shown in the figures, the present invention is an air curtain-isolated biosafety cabinet (BSC), comprising a main body 11, a door 12, an air blower 13, a suction box 14, a gas sucker 15, a plurality of cross flow fans 20 and a high efficiency particulate air (HEPA) filter 16, where air flows inside and outside the BSC are isolated with no air circulation and dissipation and thus contamination in the cabinet is well prevented from leakage.

The main body 11 has a space to contain a harmful gas to be exhausted; and has an open space at a side.

The door 12 is movably assembled to the main body 11 at a side. The door 12 has a handle 121 to move the door for controlling an opening 125. A plurality of cross flow fans 20 is set on the door 12 and the door 12 is a telescopic sliding door to change opening size of the door 12. The door blows air by setting a plurality of cross flow fans controlled by a cross-flow fan controller 2. Air is blown from upper side of the door 12 to a section of honeycombs 123. And then the air is continuously blown through a stabilizing passage 124 to dissipate turbulence energy to reach an opening 125 of the door 12.

Concerning supplying a down flow of air, the air blower 13 is controlled by an inverter 17a and is connected with the air inlet 111 on the top of the HEPA filter 16 to supply fresh air.

The suction box 14 is set beneath the main body 11; and has a suction slot 141 located at an edge of the main body 11 corresponding to the air-pushing veil 122 of the door 12.

The gas sucker 15 is set at an exit of the suction box 14 to suck the harmful gas. Another inverter 17b is used to change a rotation rate of the gas sucker 15 to control an average blowing rate of the air blower 13 and an average sectional sucking rate of the suction slot 141. A Venturi flow meter 18 is set between an exit of the gas sucker 15 and an exit of the suction box 14 to measure an air-blowing rate; and obtains a pressure difference between them with a coordination of a pressure transducer 19.

The HEPA filter 16 is deposed on top of the main body 11 to supply air in an average rate through the air blower 13. Thus, with the above structure, a novel air curtain-isolated BSC is obtained.

The present invention has the following characteristics: The door 12 is movably assembled at a side of the main body 11 and has an air-pushing veil 122. The inverter 17a is used to control the air blower 13 and the air blower 13 is connected to the air inlet 111 on the HEPA filter 16 through a flexible pipe. A plurality of cross flow fans 20 is set on the door 12; and the door is a telescopic sliding door to change a position of mouth for blowing air. The cross flow fans 20 is controlled by a cross-flow fan controller 2 to provide a steady air flow to flow from the upper side of the door 12 and to flow through a section of honeycombs 123. Then, the air is flowed through a stabilizing passage 124 to dissipate turbulence energy to reach the opening of the door 12. The suction box 14 is set beneath the main body 11 and the suction slot 141 is located at an edge of the main body 11 corresponding to the air-pushing veil 122 of the door 12, where a push-pull air-isolator is thus obtained. The flow fields of the BSC are examined through a flow visualization and are effectively controlled to prevent contamination in the cabinet from leakage; and the position of the suction slot 141 can be changed to suck the contamination more effectively. Through the HEPA filter 16 on the main body 11, fresh air flow is supplied to meet a physical mechanism between air suction and air supply. Accordingly, the air curtain-isolated BSC obtains the physical mechanism between air suction and air supply; the air-isolator formed by the local air suction near the contamination source prevents the contamination from leakage; and, thus, energy is saved and contamination is prevented from leakage with practicality, convenience and safety.

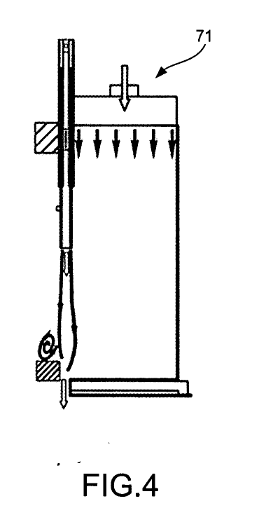

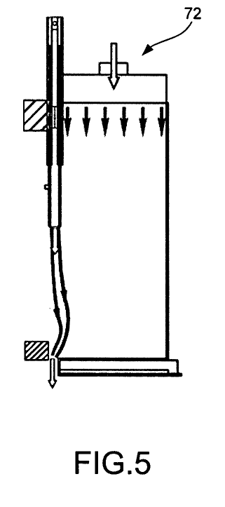

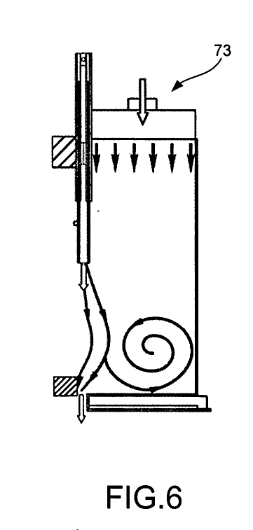

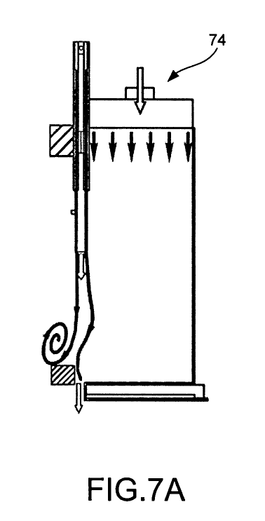

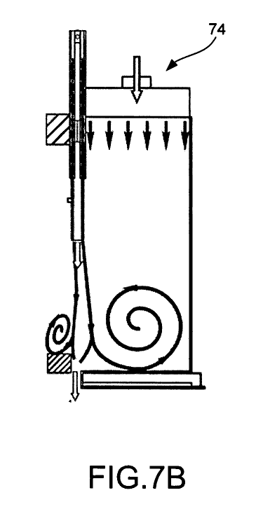

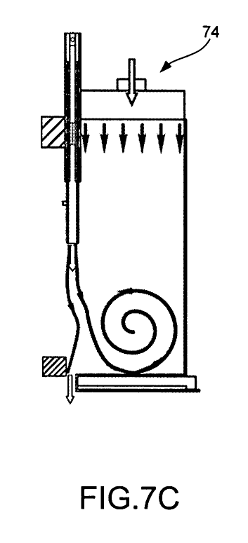

Please further refer to FIG. 4 to FIG. 7C, which are views showing a straight curtain, a slightly concave curtain and a severely concave curtain; and views showing the changes of the oscillating curtain at different times. As shown in the figures, push-pull air-isolators are divided into four type, comprising a straight curtain 71, a slightly concave curtain 72, a severely concave curtain and an oscillating curtain 74.

On using the present invention, flow fields in the main body 11 are described as follows:

(a) Slightly concave curtain 72: When an air-blowing velocity, an air-supplying velocity and an air-sucking velocity are adjusted to obtain a proper ratio, an air-isolator formed by the air from the door 12 is slightly concave inward the BSC. When the flow is close to the suction slot 141, the air flow is pulled down to be prevented from flowing outside or inside the BSC.

(b) Straight curtain 71: When the air-sucking velocity is smaller than the above one and thus is weak, the air isolator formed by the air from the door 12 is straight and not concave with no circulation formed in the cabinet.

(c) Severely concave curtain 73: When the air-sucking velocity is big, the air-isolator is moved inwardly and is severely concave; and, thus, obvious circulations are formed in the BSC.

(d) Oscillating curtain 74: Obvious circulations are generated inside and outside the BSC with the air-isolator swinging in and out of the BSC at different times.

With the above descriptions concerning the four types of flow fields, it is suggested to adjust push-pull velocities of air to obtain a slightly concave curtain 72 for operations in the BSC.

To sum up, the present invention is an air curtain-isolated BSC, where an air-isolator is formed at an opening of a door for isolating air flows inside and outside the BSC to prevent operators from damages owing to contamination leakage from the BSC, and to prevent contamination outside of the BSC from entering into the BSC to pollute a product in the BSC.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An air curtain-isolated biosafety cabinet (BSC), comprising:
a main body, said main body having a space to contain a harmful gas to be exhausted, said main body having an open space at a side of said main body;
a door, said door being movably assembled to said main body at said side of said main body to control an opening, said door having an air-pushing veil;
a high efficiency particulate air (HEPA) filter, said HEPA filter being deposed on top of said main body;
an air blower, said air blower being connected with an air inlet to supplier fresh air, said air inlet being deposed on top of said HEPA filter to supply air;
a suction box, said suction box being located beneath said main body, said suction box having a suction slot located at an edge of said main body corresponding to said air-pushing veil of said door; and
a gas sucker, said gas sucker being located at an exit of said suction box to suck said harmful gas.

2. The BSC according to claim 1,
wherein said door is a telescopic sliding door.

3. The BSC according to claim 1,
wherein, concerning supplying an air blown from said door, said air blower on an upper side of said door supplies fresh air. with an air amount and a flow velocity controlled by an inverter.

4. The BSC according to claim 1,
wherein said door has a handle to move said door to further control an opening of said door.

5. The BSC according to claim 1,
wherein said gas sucker sucks gas with a gas amount and a flow velocity controlled by an inverter

6. The BSC according to claim 1,
wherein said air blower supplies air through said HEPA filter.
